(19) United States
(12) Patent Application Publication
(10) Pub. No.: US 2017/0011473 A1
(43) Pub. Date: Jan. 12, 2017

(54) METHOD AND APPARATUS FOR SIGNING WITH AN IMAGE

(71) Applicant: Pictition Labs LLC, New York, NY (US)

(72) Inventors: Scott OSMAN, New York, NY (US); Assaf LEV, New York, NY (US)

(21) Appl. No.: 15/206,164

(22) Filed: Jul. 8, 2016

Related U.S. Application Data
(60) Provisional application No. 62/190,698, filed on Jul. 9, 2015.

(51) Int. Cl. G06Q 50/00; G06F 17/30

(52) U.S. Cl. CPC G06Q 50/01; G06F 17/30011; G06F 17/30274

(57) ABSTRACT

The system provides a method and apparatus for signing a petition or other computer based document with an image. The system collects the images, and, either automatically, or at the direction of the originator of the petition or document, can create a collection of the images of signers to represent graphically and dramatically the support for the document or petition. This collection of images in one embodiment is in the form of a mosaic of all of the image signers of the petition. After certain milestones (e.g. number of signers) the system may communicate with each existing signer to show them the mosaic and to encourage further activity.

This application claims priority to U.S. Provisional Patent Application Ser. No. 62/190,698 filed on Jul. 9, 2015, which is incorporated by reference herein in its entirety.

### BACKGROUND OF THE SYSTEM

There are a number of instances where people start a petition to register a protest, express an opinion, accomplish a goal, qualify for political office, and the like. A petition may be used to save a TV show from being cancelled, to protest some action by others, to support actions of others, or to show solidarity with others of similar views. The ability to start a petition has been automated to some extent by the Internet. For example, at sites such as www.change.org, a user can take advantage of the sites tools to start a petition, to find petitions started by others, or to sign petitions of which the user is aware.

Although the ability to create petitions has been improved through the use of computer implemented systems and web sites, the operation of a petition is relatively unchanged. If a user finds a petition in which the user wishes to participate, the user signs the petition by appending their name, a digital signature, or an email address or other account information and joins others who have already signed. The result is a petition that includes a long list of names of those who have signed the petition.

### SUMMARY

The system provides a method and apparatus for signing a petition or other network based document with an image. The system collects the images, and, either automatically, or at the direction of the originator of the petition or document, can create a collection of the images of signers to represent graphically and dramatically the support for the document or petition. This collection of images in one embodiment may be in the form of a mosaic of all of the image signers of the petition. The system provides an ability for users to initiate a call to action to seek others to sign the petition. A site allows the user to find the petition and to join in the campaign represented by the petition. The user selects an image with which to sign the petition. In one embodiment, the user creates an account or links an existing account (e.g. a social media account) with the petition. The user can share the petition with others and can provide links on social media accounts. After certain milestones (e.g. number of signers) a mosaic of images can be created and provided for use in advertising, publishing, or other avenues to promote or reflect the petition and campaign. The milestones may be used as points to communicate with each existing signer to show them the mosaic and to encourage further activity.

### BRIEF DESCRIPTION OF THE DRAWINGS

FIG. 1 is a flow diagram illustrating the image signing of a document.

FIG. 2 is a flow diagram illustrating milestone operation in one embodiment of the system.

FIG. 3 is a flow diagram illustrating mosaic generation in an embodiment of the system.

FIG. 4 illustrates one embodiment of a mosaic.

FIG. 5 illustrates another embodiment of a mosaic.

FIG. 6 is a flow diagram illustrating the operation of the system when a user signs a petition.

FIG. 7 is a flow diagram illustrating the operation of the system when a user makes changes to the image signature.

FIG. 8 illustrates an example processing system for implementing the system.

FIG. 9 is a block diagram of an embodiment of the system.

### DETAILED DESCRIPTION OF THE SYSTEM

The system provides a method and apparatus for signing an electronic document with an image. In the following discussion, the system will be described in connection with the signing of a petition. However, the petition is by way of example only, and other documents may be signed with an image without departing from the scope and spirit of the system.

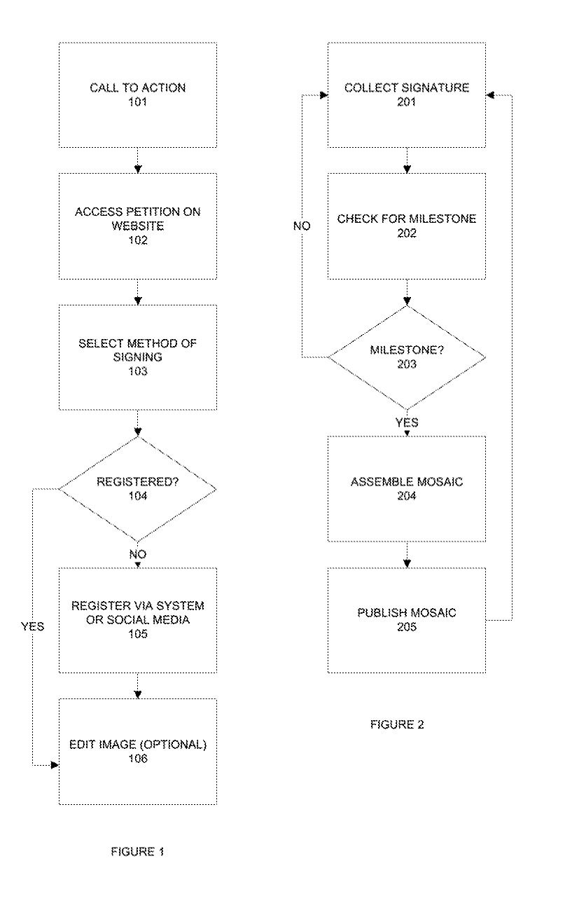

FIG. 1 is a flow diagram illustrating the operation of signing in one embodiment of the system. At step 101 the system provides a call to action. The call to action is a request to participate in a campaign associated with a petition. It should be noted that an actual petition is not required. The system contemplates that the campaign may be described and the user may signify support for the campaign via an image signature. In other embodiments, a petition may include a specific message, statement, or position and the user indicates support by signing the statement. The call to action at step 101 may be from the system itself, via advertising, social media, email, presentation on the system website, and the like. The call to action could also be from third parties, friends of a user, texts, previous signers of the petition, and the like. The system may be accessed by any computing device including desktop computers, laptops, tablets, smart watches, smart phones, personal digital assistants, the internet of things (IOT), or any suitable device.

In one embodiment the call to action may be a widget that can embed a smaller version of a petition mosaic on any web page or network location. The system allows the user to sign with a picture within the widget as if they were interacting with the system directly.

At step 102, in response to the call to action, a user accesses the system website (or a website created for the campaign and linked to the call to action) and is presented with the campaign/petition. At step 103 the system offers the user one or more options to sign the petition. For example, the user may be offered an option to sign the petition using one of a plurality of social media accounts (e.g. Facebook, Twitter, and the like). The user selects one of the signing methods and, in one embodiment, the system selects the users profile picture from the social media account to use as the image signature.

After signing, the system checks to see if the user is registered in the system at decision block 104. If not, the system can register the user at step 105 at the campaign website, or the system can register the user via a user's social media account (e.g. Facebook, Twitter, and the like). In one embodiment, the system shows the user a plurality of choices for sign-in and registration. In one embodiment the system displays statistics associated with the number and/or percentage of signers who have used each sign-in method.

In one embodiment, the system uses a “Real-Name” registration system requiring the use of identification credentials and the user's legal name for registration, although a pseudonym may be used on-line once registration is complete. In other instances, anonymous registration may be used.

After registration at step 105, or if the user is already registered at step 104, the system proceeds to step 106. At this step, the user may edit the image signature and/or may selects another image with which to sign the petition. In some cases, the campaign may require a facial image. Generally the image is available to the user via the user's device, via the user's cloud storage, via social media, or some other manner by which the user can offer an image for use as an image signature.

In other embodiments, the system may permit the user to select any image, even if it is not a facial image. In one embodiment, the user may use a .gif image instead of a still image to sign the petition. In the mosaic, the .gif may be moving constantly or may have an indicator that it is a .gif and may activate when a viewer hovers over the image and/or selects the image. Similarly, the image may be a video that shows a thumbnail when not selected and is activated when a viewer chooses to hover over, and/or select the image.

During the signing, registration, and/or editing operations, the system updates campaign information and databases with the information from the signing user.

User Feedback

After a user has signed a petition using the system, a number of actions take place as described in the flow diagram of FIG. 6. At step 601 the user signs a petition with an image. At step 602 the system adds the image to a database of images associated with the petition. At step 603 the system adds metadata to the image including time, date, userid, social media connections, permissions the user may have authorized, and the like. In some cases, the signing of the petition may involve a request for a voluntary contribution. Whether the user has made a contribution may also be included in the metadata associated with the image. In one embodiment, other metadata may include total number of petitions and/or documents signed by the user, channel/link information about the user, comment information, and change picture information.

At step 604 the system displays the image signature to the user, so that the user can have visual confirmation of the signing of the petition. This may be as part of a photo mosaic generated by the system, with the user in a particular location (e.g. upper left corner) signifying a most recent signee of the petition, or it may be in some other location as desired. If the user had accessed the system via a widget, the user's picture will show up in the widget display after the user signs.

At step 605 the system updates the user permissions associated with the other images in the petition. Prior to signing, in one embodiment a user can hover over the tile of a prior signer and see an expanded view of the image along with some limited information (e.g. time of signing). After signing the petition, the user can see more information when hovering over, and/or selecting an image tile of the mosaic. The system provides an active mosaic that reacts to cursor position over the image. In a touch screen environment, the user may hold a finger or pointer on the image tile to additional data. In other embodiments the user may tap on a tile to trigger the display of name and/or comment information.

For example, in one embodiment the user can see the name of the signing person, as well as any comments that have been left by that person. For example, if a user has entered any comments, that tile may have an overlay and/or outline of a word balloon graphic or some other indicator that a comment has been left. The user may hover over the image and/or select the image to read the comments. In one embodiment, the user can respond to the comments in a dialogue string.

In one embodiment, each image includes the ability to display and/or invoke a “like” button that allows the user to like other image signatures and/or comments. The system may also include a counter system illustrating number of likes, view, comments, and the like.

At step 606 the system communicates with the user by email, text, SMS message, Facebook post, Twitter tweet, and the like. The user may select the method of communication. In one embodiment, the system defaults to an email address associated with the social media account form which the user signed the petition and provides a communication via that email address. The communication may include a thank you, a sharing link so that the user can send the petition and the user image to others, as well as additional information about the petition sponsor.

At step 607 the system updates the user profile, with lists and links to all petitions signed by the user as well as suggestions and recommendations to the user of other petitions that may be of interest to the user. The recommendation may be based on interests, most recent signed petitions, based on demographics, based on petitions signed by friends of the user, based on geo-location, and the like. The user can also see friends, likes, and other related metrics associated with activity by the user with the system and individual petitions.

Changes/Updates

In one embodiment the system allows the user to manipulate the image signature after signing. FIG. 7 is a flow diagram illustrating the operation of the system when the user updates an image signature. At step 701 the user opens the petition of interest. In one embodiment the system automatically scrolls to the portion of the petition with the user's image and highlights it so the user can easily interact with the users picture signature. In another embodiment the system has a search tool where the user can search for their image (or any other image).

At decision block 702 the system determines if the user has changed the image signature. In one embodiment, when the user hovers over or selects the user's image, a set of tool icons appear that the user can select to initiate changes on the image. If the user has changed the image at decision block 702, the system updates the image and immediately shows it to the user as part of the mosaic.

If there is no image change at 702, or after step 703, the system proceeds to decision block 704 to determine if the user has entered a comment associated with their image. If so, the system proceeds to step 705 and updates the image to include the comments and an icon or other indicator that represents that the image has an associated comment.

If there is no comment at 704, or after step 705, the system proceeds to decision block 706 to determine if the user has identified friends associated with the petition. If so, the system proceeds to step 707 and re-sorts the mosaic so that the user and the identified friends appear near each other in the mosaic. If the user has not identified friends at 706, or after step 707, the system proceeds to step 708.

In another embodiment, different weighting factors may be used to determine a sorting or ordering of the mosaic. As noted above, a user may be positioned near identified friends. In some cases, users with higher number of likes are sorted near each other (possibly at the beginning of the mosaic or some other desired position). In one embodiment, a user who was signed a larger number of petitions may have preferred placement. In one embodiment the mosaic is sorted in a customized manner for each viewer/user/signer. In one embodiment, the system offers a sort tool that allows each user to custom sort the mosaic according to user selected criteria.

At step 708 the system may send automatic posts to the user confirming the update, along with posts to those social media accounts that the user has indicated in the user preferences. The post can be automatically shared on the social media network pursuant to permissions and settings of the user. In one embodiment, the system provides a feed showing updates, comments, posts, and the like on the campaign page, with options to also share the posts on social media accounts.

In addition to sorting the mosaic by the identification of friends, the system can sort the mosaic by a number of other metrics as well, including, but not limited to, geography, gender, age, influence, and the like.

The sorting of the mosaic may also be based on number of petitions signed by any one signer, number of likes, number of views, and the like.

In one embodiment, the system tracks the influence of a user. This may be accomplished by tracking the number of new signers that respond to a share link of the user. The influence may be based on a time period (day, week, month, year, and the like). In one embodiment, the influencer will have their image near those of signers that have signed as a result of the actions of the influencer.

In one embodiment, the influencer has a unique landing page that shows a customized version of the mosaic based on that influencers activities, friends, likes, etc. In one embodiment, each user has a customized landing page that provides a custom sort of the signature mosaic for that user, based on metrics selected by that user (e.g. be close to friends, similar geography, similar ages, and the like).

Milestones

The system contemplates the generation of mosaics of image signatures at certain milestones of a campaign. FIG. 2 is a flow diagram illustrating milestone operation of the system in one embodiment. At step 201 the system collects a signature from a user that has signed a petition with an image. At step 202 the system checks to see if a milestone has been reached.

The milestone may be an automatically generated milestone based on one or more target signature totals that are defined by the system. For example, the system may establish a milestone at every 1,000 signatures, every 100,000 signatures, and the like. Any number may be used as desired. The milestones may be regular (e.g. every X signatures) or may be irregular with varying thresholds, (e.g. first milestone is 1,000, second is 5,000, third is 100,000, and the like). In one embodiment, the originator of the campaign can select the milestones that will be associated with the campaign. This may be in lieu of, or in addition to, any milestones that may be automatically established by the system. In one embodiment, each signer of the petition may establish milestones themselves.

At decision block 203 it is determined if a milestone has been reached. If not, the system returns to step 201 to continue to collect signatures. If so, the system proceeds to step 204. At step 204 the system assembles the milestone number of images into a mosaic. For example, if the milestone is 100 images, the system assembles the images into a mosaic where each tile in the mosaic is one of the submitted images. In one embodiment, the system may assemble the images in the order received, or it may randomly assign locations in the mosaic as desired. Any assembly scheme can be utilized as desired. In assembling the mosaic, the system may automatically resize each submitted image into a fixed size (e.g. in the manner of creating thumbnail images). This may involve cropping or stretching the submitted images to match the tile size of the mosaic. In other instances, the system may keep the proportions of each image as submitted and add shading or borders as appropriate so that the overall mosaic can fit into a desired shape. In one embodiment, the images are normalized upon receipt by the system so that mosaic assembly can be achieved without further processing.

In one embodiment, the mosaic may use rectilinear tiles for individual images and an overall rectilinear shape of the mosaic. In other instances, the mosaic may be some other geometric shape. In one embodiment, the mosaic may be on a glove or other three dimensional image and rotate so that all images may be exposed to a viewer.

At step 205 the system publishes the mosaic. In one embodiment, the publication may comprise sending the mosaic to each signer of the campaign. In one embodiment, the mosaic may be published on the campaign website, presented in an advertising campaign in print or video, or assembled in a published book to create a permanent record of the campaign. In one embodiment, each time a milestone is achieved, all pictures accumulated to that point are assembled into a mosaic. In one embodiment, each time a milestone is reached, only those images accumulated since the prior milestone are assembled into a mosaic. In another embodiment, each time a milestone is reached, a custom mosaic is generated that includes the presence of friends of each user near each other in the mosaic and possibly positioned at a particular location (e.g. center, top left, and the like). In one embodiment, a custom mosaic is assembled for each user where the position of the user is in a particular position, such as center, top left, and the like.

Mosaic Generation

FIG. 3 is a flow diagram illustrating the mosaic generation in an embodiment of the system. At step 301 the system receives a instruction to generate a mosaic. This can be the result of a milestone being reached, or a direct request to generate a mosaic, or via some other condition. At step 302 the system collects the images that are to be used in creating the mosaic. As noted above, this can be all images up to and including the current milestone image, only images since the prior milestone, or any combination of images as desired.

At step 303 the system normalizes the images for the mosaic. This is done by determining the dimensions of the mosaic (e.g. how many rows and columns of the mosaic) and sizing the images accordingly. At decision block 304 it is determined if the mosaic is to be a custom mosaic where the images are to be arranged or ordered pursuant to a custom rule. If so, the system assembles one or more custom mosaics at step 305. If not, the system assembles a mosaic at step 306.

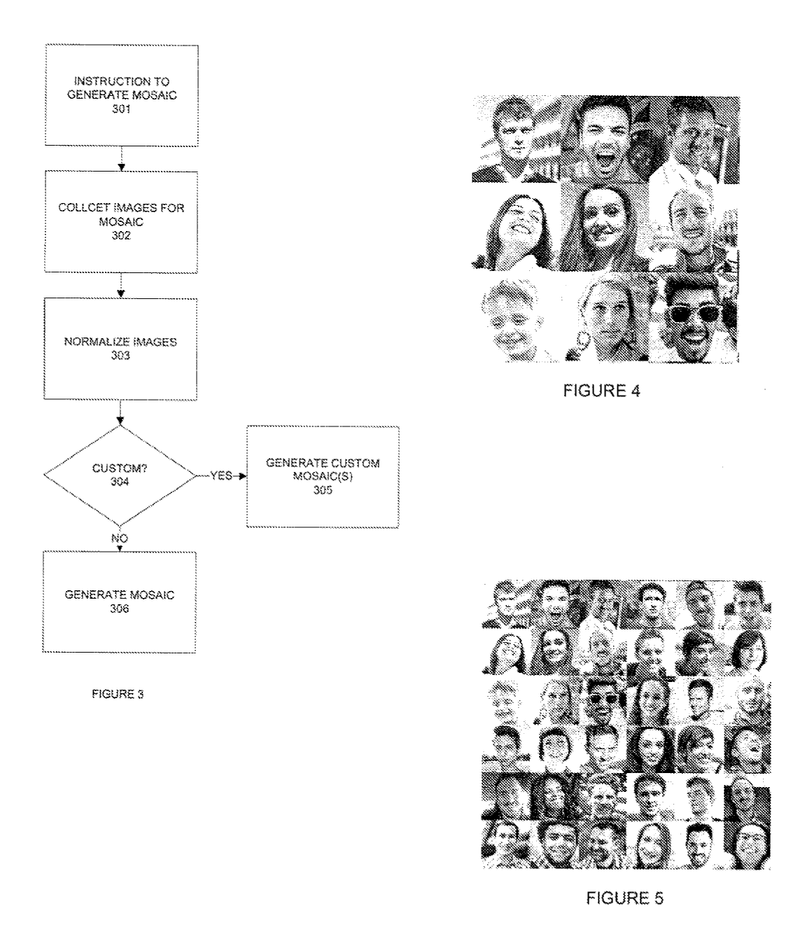

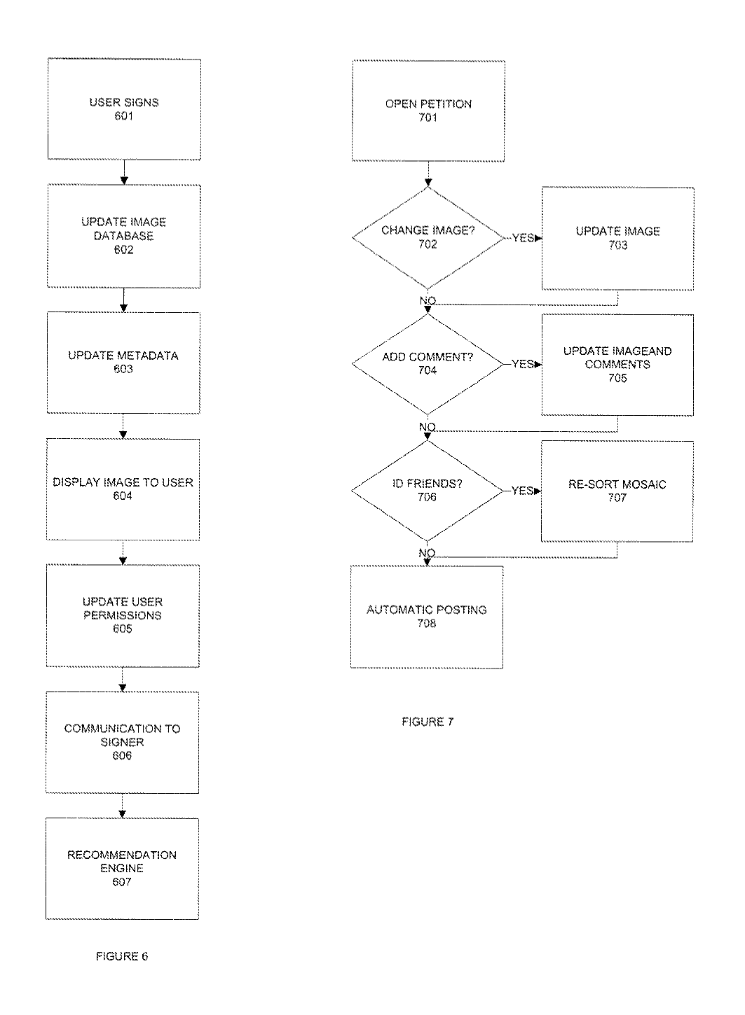

FIGS. 4 and 5 illustrate example mosaics using the system. FIG. 4 illustrates a 3×3 mosaic where nine image signatures are assembled into a mosaic. FIG. 5 illustrates a 6×6 mosaic containing 36 image signatures.

Client Operation

The system contemplates the ability of a petition organizer to define parameters associated with a campaign. This includes the aesthetic appearance of the campaign page (e.g logo, background colors, and the like) as well as practical aspects of the campaign. This can include campaign goals, mosaic milestones, permissible social networks for sign-in (for example a client may wish to limit signatures to facebook, twitter, or some other social network or sign-in method). The system allows the client to use a widget tool to add a petition widget to other websites, ads, links and the like.

The client interface also defines the type of information requested from a signer, the ability to comment or not, the type of thank you communication, the ability to request a monetary contribution, and the like. The system can also allow the client to define metrics for influencers to receive upgrades and advantages (e.g. picture placement preference and the like).

Document Signing with Image

In one embodiment, the system provides a method for signing a document with a user image. The system contemplates a user selecting an image to represent the user's legal signature. When a document is to be digitally signed, the user selects the image and uses it as the user's signature. The image signature may be verified using any of a number of authentication systems, including public key encryption, digital signature techniques, and the like. In one embodiment the system uses facial recognition for verification and authentication of the signatory.

In one embodiment, the system could require biometric identification before permitting signing. This would serve to verify and authorize the signing party.

The system is not limited to the signing of petitions. The signing of petitions is used by way of example in the present application. The system may also be applied to any document that requires a signature. The system may also be used in connection with sweepstakes, contests, and other events. In a sweepstakes embodiment, the signing of a sweepstakes campaign page automatically enters the signing party into the sweepstakes.

FIG. 9 is a block diagram of an embodiment of the system. One or more Users 901A, 901B, through 901N can interact with the system via a Network 902. A user may be a person who will sign a petition or it may be a client requesting a petition to be generated. The network 902 may be the internet, mobile network, cellular network, or some other suitable wired or wireless network.

The system includes an Authorization/Biometrics/Facial Recognition module 903 that is used when required to provide authorization and verification of users, clients, and signers of the various documents and petitions. Module 903 is coupled to User Database 905 and Campaign Database 904 so that those databases can be accessed for verification and updated as appropriate. The User Database 905 is coupled to a Social Network Interface 906 that includes SDKs and APIs for access to the plurality of social networks that can be used to implement an image signature in the system. A Mosaic Generator 907 is used to prepare and display the mosaic of image signatures, to sort the mosaic pursuant to metrics associated with the image signatures, and to provide other communication to the users and campaign clients as appropriate.

Example Computer System

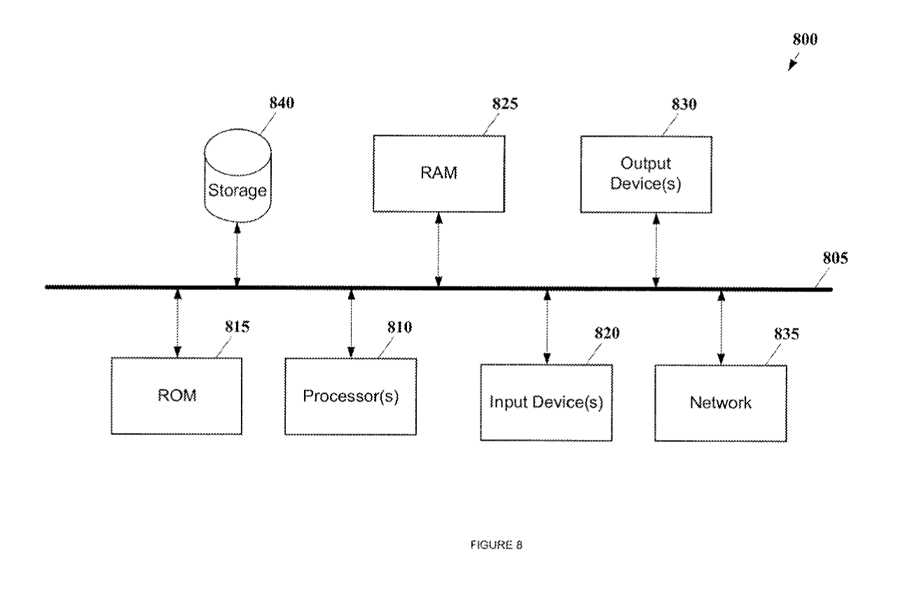

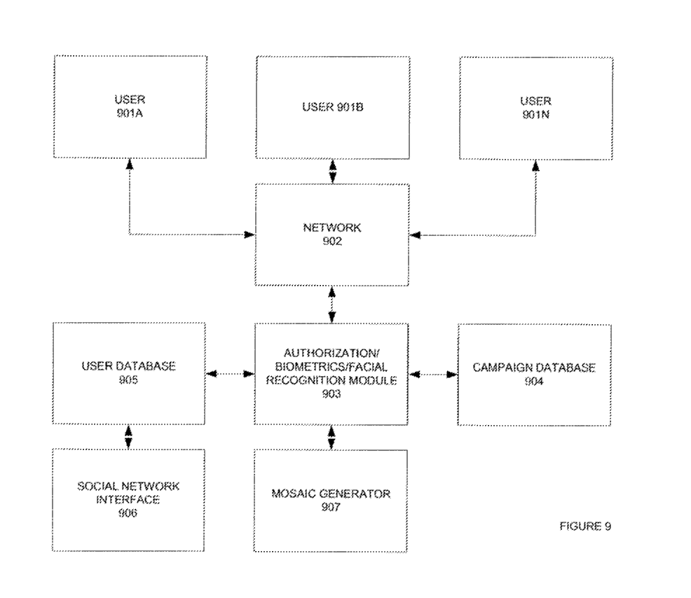

FIG. 8 illustrates an exemplary computer system 800 that may implement the image signature system. The computer system includes various types of computer readable media and interfaces. The system includes a bus 805, processors 810, read only memory (ROM) 815, input device(s) 820, random access memory 825), output device(s) 830, a network component 835, and a permanent storage device 840.

The bus 805 the communicatively connects the internal devices and/or components of the computer system. For instance, the bus 805 communicatively connects the processor(s) 810 with the ROM 815, the RAM 825, and the permanent storage 840. The processor(s) 810 retrieve instructions from the memory units to execute processes of the invention.

The ROM 815 stores static instructions needed by the processor(s) 810 and other components of the computer system. The ROM may store the instructions necessary for the processor to execute the web server, web application, or other web services. The permanent storage 840 is a non-volatile memory that stores instructions and data when the computer system 800 is on or off. The permanent storage 840 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The RAM 125 is a volatile read/write memory. The RAM 825 stores instructions needed by the processor(s) 810 at runtime. The bus 805 also connects input and output devices 820 and 830. The input devices enable the user to communicate information and select commands to the computer system. The input devices 820 may be a keyboard or a pointing device such as a mouse. The input devices 820 may also be a touch screen display capable of receiving touch interactions. The output device(s) 830 display images generated by the computer system. The output devices may include printers or display devices such as monitors.

The bus 805 also couples the computer system to a network 835. The computer system may be part of a local area network (LAN), a wide area network (WAN), the Internet, or an Intranet by using a network interface. The web service may be provided to the user through a web client, which receives information transmitted on the network 835 by the computer system 800.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for” or, in the case of a method claim, the element is recited using the phrase “step for.”

What is claimed is:

1. A method of signing a document comprising:
in a processing system;
providing a document to be signed by a user;
providing a plurality of methods of selecting an image of the user;
selecting one of the plurality of methods;
using the selected image as a signature on the document.

2. The method of claim 1 wherein the plurality of methods of selecting an image comprises plurality of social media accounts.

3. The method of claim 2 wherein the selected image is a profile picture of the selected social media account.

4. The method of claim 3 wherein the selected image is an image selected by the user from the selected social media account.

5. The method of claim 4 wherein the document comprises a petition.

6. The method of claim 5 wherein the system generates a mosaic of image signatures of each user that signs the petition.

7. The method of claim 4 wherein the document is a sweepstakes offer.

8. The method of claim 7 wherein the image signature acts as an entry into the sweepstakes.
